(19) United States
(12) Patent Application Publication
(10) Pub. No.: US 2001/0011630 A1
(43) Pub. Date: Aug. 9, 2001

(54) Switch actuating mechanism

(75) Inventors: Jochen Loschner, Radolfzell (DE); Lars Kukei, Itzehoe (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Electronics & Components GmbH & Co. KG

(21) Appl. No.: 09/772,840

(22) Filed: Jan. 30, 2001

(30) Foreign Application Priority Data
Feb. 3, 2000 (DE) 200 01 869.8

(51) Int. Cl. H01H 25/04

(52) U.S. Cl. 200/6 A

(57) ABSTRACT

Switch actuating mechanism comprising a toggle lever which includes a bearing part guided pivotably to all sides in a base and a shank secured to the bearing part, and which is pivotable in any direction starting from a central resting position. The shank is biased into the resting position by spring force, which is provided by a spring disk axially supported by the bearing part and having an outer circumference contacting an inside contact surface area of the base surrounding the bearing part.

### FIELD OF THE INVENTION

The invention relates to a switch actuating mechanism comprising a toggle lever which includes a bearing part guided pivotably to all sides in a base and a shank secured to the bearing part.

### BACKGROUND OF THE INVENTION

In such a switch actuating mechanism which may be used for switches such as mirror setting switches in vehicles or joy stick controls for game consoles and the like the toggle lever is pivotable in any direction from a central resting position and biased into the resting position by spring force.

Depending on the function demanded of the switch the switch actuating mechanism needs to comprise freedom of movement in corresponding degrees which may be coupled with various return forces and latching positions. Complex movement patterns are achievable with a corresponding array of matched components.

### BRIEF SUMMARY OF THE INVENTION

The invention provides a switch actuating mechanism which permits a complex movement pattern for the toggle lever with a minimum component requirement. In accordance with the invention the switch actuating mechanism is equipped with a spring disk axially supported by the bearing part of the toggle lever and having an outer circumference contacting an inside contact surface area of the base, the inside contact surface area surrounding the bearing part. This spring disk alone is able to provide the return forces for returning the toggle lever into its central resting position from the actuated position. In the preferred embodiment the spring disk is dished, its concave side facing the contact surface area of the base. It is this configuration of the spring disk that results in its actuating and return force having a degressive characteristic.

Also in the case of an embodiment comprising a toggle lever rotatable about its longitudinal centerline the spring disk is able to provide the force needed to return the toggle lever into its resting position, the toggle lever being coupled to the spring disk for joint rotation in this embodiment. The spring disk and the contact surface area at the inner side of the base are shaped to cooperate with each other, more particularly have ramp faces sliding one on the other so that the spring force is able to generate a force component acting circumferentially. For providing latching positions the spring disk and the contact surface area are additionally or alternatively shaped to cooperate with each other in defining several latching positions of the toggle lever.

### BRIEF DESCRIPTION OF THE DRAWINGS

Further features and advantages of the invention read from the following description and are evident from the attached drawings to which reference is made and in which:

FIG. 1 is a schematic partial section view of a switch actuating mechanism;

FIG. 2 is a schematic view in perspective of a spring disk of the actuating mechanism;

FIG. 3 is a schematic section view of the spring disk;

FIG. 4 is a plan view of the spring disk;

FIGS. 5 and 6 illustrate two aspects of the invention.

### DETAILED DESCRIPTION OF THE INVENTION

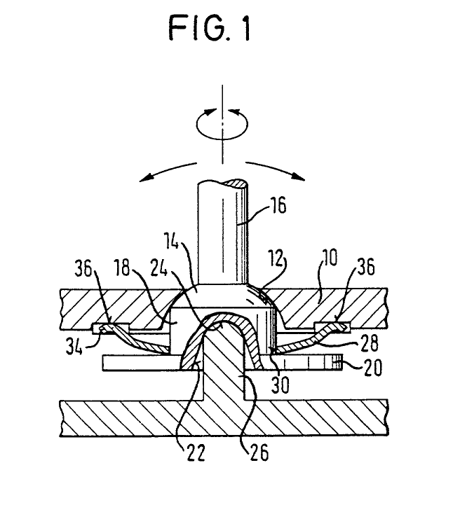

Referring now to FIG. 1 there is illustrated the switch actuating mechanism arranged in a base or housing of which only a wall part 10 is shown in FIG. 1. Formed in this wall part 10 is a domed bearing mount 12. Accommodated in this bearing mount 12 is a corresponding domed bearing part 14 of a toggle lever of which in addition to the bearing part 14 a shank 16 connecting thereto is evident from FIG. 1. Adjoining the domed portion the bearing part 14 has a cylindrical part 18 and at its end facing away from the shank 16 a radially protruding flange 20 in the shape of a circular disk. The center opening 22 of the flange 20 has a continuation at the inner side of the bearing part 14 where it forms a concave rounded supporting surface area 24. A bearing pin 26 supported by the base of the actuating mechanism extends through the center opening 22 and contacts the concave rounded supporting surface area 24 by its crowned free end.

Mounted on the cylindrical part 18 of the bearing part 12 is a circular dished spring disk 28 axially supported by the annular flange 20. The concave side of the disk spring 28 faces the inner side of the wall part 10. The spring disk 28 has a central hole 30, the shape of which corresponds to the outer circumference of the cylindrical part 18 of the bearing part 14 which is non-rotatively connected to the spring disk 28 by two diametrically opposed notches 32 in the opening 30 and by fins engaging the latter on the bearing part 14.

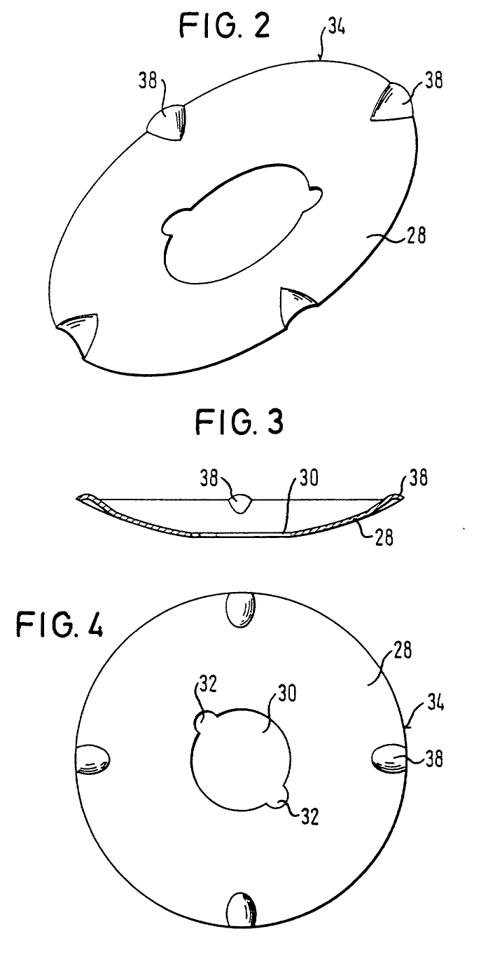

By its outer circumference the spring disk 28 contacts an inner side annular contact surface area 36 of the wall part 10. In the embodiment shown this annular contact surface area 36 is inset in the wall part 10. Referring now to FIG. 2 there is illustrated the spring disk 28 including at its outer circumference 34 a number of embossed cams 38, namely four contact cams spaced away from each other angularly at 90°. The number and arrangement of the cams 38 is dictated by the function of the switch to be actuated. These cams 38 are shaped to cooperate with corresponding contact surface areas 36 in defining the latching positions. These latching positions materialize in rotation of the toggle lever 16 about its longitudinal centerline.

The toggle lever formed by the bearing part 14 and shank 16 can be swivelled from its resting position as shown in FIG. 1 in all directions whilst being rotatable about its centerline. The spring disk 28 provides the toggle lever in each deflected position with a return force capable of returning it to the resting position as shown in FIG. 1. Due to the dished shape of the spring disk 28 the actuating and return forces have a degressive characteristic. The spring disk 28 is also able to provide the return forces needed for the bias rotation of the toggle lever towards its central resting position. For this purpose the cams 38 run on ramp-shaped surface areas of the contact surface area 36. Due to the axial pressure on these ramp-shaped surface areas circumferentially oriented force components are generated.

The switch actuating mechanism described satisfies with but a few components all requirements for complex switching functions and switch positions. The simple configuration of the actuating mechanism permits rational mass production. The switching sensitivity of the actuating mechanism can be determined to a major degree by the finish of the spring disk 28, the salient parameters of which are the selection of the material, material thickness, domed radius as well as disk and hole diameter.

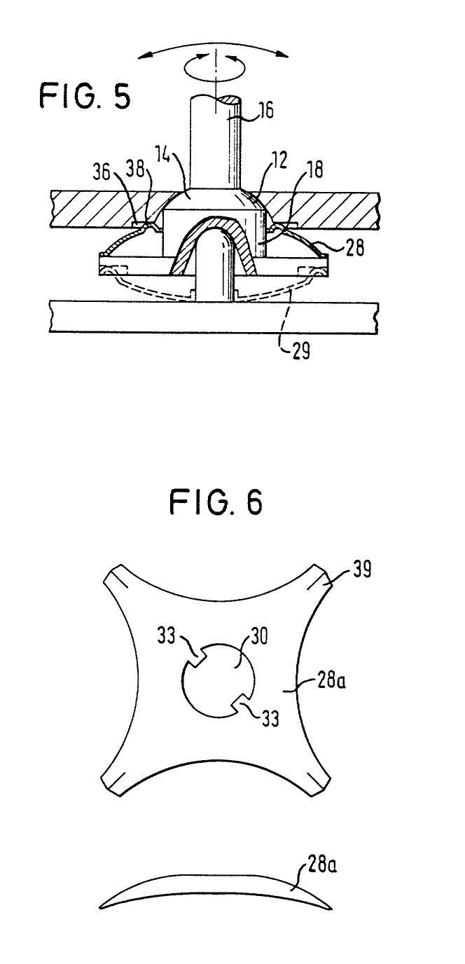

Referring now to FIG. 5 there is illustrated an aspect in which the curvature of the spring disk 28 contacts the base by its convex side. As an alternative or in addition thereto, as indicated by the broken line in FIG. 5, the circumferential edge of the flange 20 rests on a spring disk 29 resting on the bottom of the base and surrounding the bearing pin 26.

Referring now to FIG. 6 there is illustrated an aspect of the spring disk 28a other than circular. Instead of the notches 32 as shown in FIG. 4 two cams 33 are formed in the opening 30 to prevent rotation. Furthermore, the spring disk 28a features four contact and supporting lugs 39 spaced away from each other angularly at 90°.

1. A switch actuating mechanism comprising a toggle lever which includes a bearing part guided pivotably to all sides in a base and a shank secured to the bearing part and which is pivotable in any direction starting from a central resting position, said shank being biased into the resting position by spring force, wherein said spring force is provided by a spring disk axially supported by said bearing part and having an outer circumference contacting an inside contact surface area of said base, said inside contact surface area surrounding said bearing part.

2. The switch actuating mechanism as set forth in claim 1, wherein said spring disk is dished with a concave side facing said contact surface area of said base and said outer circumference bearing on said contact surface area of said base.

3. The switch actuating mechanism as set forth in claim 1, wherein said spring disk is dished with a convex side facing said contact surface area of said base and said outer circumference bearing on said toggle lever.

4. The switch actuating mechanism as set forth in claim 1, wherein said toggle lever is rotatable about a longitudinal centerline and coupled to said spring disk for joint rotation.

5. The switch actuating mechanism as set forth in claim 4, wherein said spring disk and said contact surface area are shaped to cooperate with each other in defining at least two rest positions of said toggle lever.

6. The switch actuating mechanism as set forth in claim 4, wherein said spring disk and said contact surface area have ramp faces sliding one on the other and which, in cooperation with the spring force of said spring disk, produce a return bias of said toggle lever towards said central resting position.

7. The switch actuating mechanism as set forth in claim 1, wherein said bearing part comprises a bearing surface area in the shape of a spherical segment and at its side facing away from said bearing surface area a concave supporting surface area which is engaged by a bearing pin having a crowned end.

8. The switch actuating mechanism as set forth in claim 1, wherein a radially protruding flange supporting said spring disk is arranged circumferentially on said bearing part.

9. The switch actuating mechanism as set forth in claim 1, wherein said spring disk is generally circular with a center opening for mounting on said bearing part.

10. The switch actuating mechanism as set forth in claim 1, wherein said spring disk comprises radially protruding lugs, that have both of a supporting and a contacting function.
